(19) United States
(12) Patent Application Publication
(10) Pub. No.: US 2021/0370960 A1
(43) Pub. Date: Dec. 2, 2021

(54) SYSTEMS AND METHODS FOR MONITORING AN OPERATION OF ONE OR MORE SELF-DRIVING VEHICLES

(71) Applicant: Clearpath Robotics Inc., Kitchener (CA)

(72) Inventors: Guillaume Michel Autran, Kitchener (CA); Jin-Myung Won, Kitchener (CA); James Servos, Kitchener (CA); Ryan Christopher Gariepy, Kitchener (CA); Shahab Kaynama, Kitchener (CA)

(21) Appl. No.: 17/162,481

(22) Filed: Jan. 29, 2021

Related U.S. Application Data
(60) Provisional application No. 62/964,231, filed on Jan. 22, 2020.

(51) Int. Cl. B60W 50/035; G07C 5/02; G07C 5/00; B60W 50/02; G07C 5/08

(52) U.S. Cl. CPC B60W 50/035; G07C 5/02; G05D 1/0055; B60W 50/0205; G07C 5/085; G07C 5/008

(57) ABSTRACT

The various embodiments described herein generally relate to systems and methods for monitoring an operation of one or more self-driving vehicles. The method involves operating a vehicle processor of a self-driving vehicle to: collect, during operation, operation data associated with the operation of the self-driving vehicle; detect, from the operation data, a trigger condition is satisfied during the operation; determine, for the trigger condition, a pre-condition period and a post-condition period, the pre-condition period defining a time period before the trigger condition occurred and the post-condition period defining a time period following the trigger condition; retrieve, from a vehicle data storage, the subset of the operation data collected by the self-driving vehicle during the pre-condition period and the post-condition period; and transmit the subset of the operation data to the data analysis system.

### CROSS-REFERENCE TO RELATED APPLICATIONS

This application claims priority from U.S. Provisional Patent Application No. 62/964,231, filed Jan. 22, 2020, the contents of which are incorporated herein by reference.

### FIELD

The various embodiments described herein generally relate to self-driving vehicles and in particular, to systems and methods for monitoring an operation of one or more self-driving vehicles.

### BACKGROUND

Autonomous or self-driving vehicles are increasingly used for various different applications. On roads, for example, self-driving vehicles include autonomous cars, and in industrial environments, self-driving vehicles include autonomous material-transport vehicles. A self-driving vehicle typically includes various sensors for sensing its environment to facilitate autonomous navigation within its environment with minimal to no human input. As the complexity of the hardware and the autonomous operation of a self-driving vehicle increases, the volume of data generated by the self-driving vehicle also increases significantly. In example implementations involving large fleets of self-driving vehicles, and/or tasks that involve the coordination of multiple self-driving vehicles, a large quantity of data will typically be generated. The management and/or analysis of that data, however, can be difficult and can consume a large amount of computing resources and time.

### SUMMARY

The various embodiments described herein generally relate to methods (and associated systems configured to implement the methods) for monitoring an operation of one or more self-driving vehicles.

In accordance with some embodiments, there is provided a method for monitoring an operation of one or more self-driving vehicles. The method involves operating a vehicle processor of a self-driving vehicle to: collect, during operation, operation data associated with the operation of the self-driving vehicle; detect, from the operation data, a trigger condition is satisfied during the operation; determine, for the trigger condition, a pre-condition period and a post-condition period during which a subset of the operation data is to be retrieved for analyzing the operation of the self-driving vehicle in respect of the trigger condition, the pre-condition period defining a time period before the trigger condition occurred and the post-condition period defining a time period following the trigger condition; retrieve, from a vehicle data storage, the subset of the operation data collected by the self-driving vehicle during the pre-condition period and the post-condition period; request a transmission policy from a data analysis system remote from the self-driving vehicle via a network, the transmission policy defining one or more transmission parameters for transmitting the subset of the operation data to the data analysis system; and transmit the subset of the operation data to the data analysis system according to the transmission policy.

In some embodiments, retrieving the subset of the operation data collected by the self-driving vehicle during the pre-condition period and the post-condition period may involve associating the subset of the operation data with at least one description identifier related to the trigger condition.

In some embodiments, detecting the trigger condition is satisfied during the operation may involve: detecting at least one trigger condition of a plurality of trigger conditions is satisfied; and continuing to detect whether one or more other trigger conditions is satisfied.

In some embodiments, detecting the trigger condition is satisfied during the operation may involve: detecting, from the operation data, an error at the self-driving vehicle.

In some embodiments, detecting the error at the self-driving vehicle may involve: receiving at least two conflicting data inputs related to the operation of the self-driving vehicle.

In some embodiments, receiving the at least two conflicting data inputs may involve: receiving a first data input from a first sensor indicating a first condition; and receiving a second data input from a second sensor indicating a second condition opposite from the first condition.

In some embodiments, detecting the trigger condition is satisfied during the operation may involve: detecting, from the operation data, a completion of a mission assigned to the self-driving vehicle.

In some embodiments, detecting the trigger condition is satisfied during the operation may involve: detecting receipt of a user-triggered condition.

In some embodiments, detecting the trigger condition is satisfied during the operation may involve: detecting, from the operation data, a state change at the self-driving vehicle.

In some embodiments, the method may further involve operating the vehicle processor to: determine an occurrence rate of the state change exceeds an occurrence threshold; and in response to determining the occurrence rate exceeds the occurrence threshold, initiate a cool-down period following the post-condition period during which the vehicle processor operates to retrieve and transmit a reduced subset of operation data as the subset of the operation data.

In some embodiments, collecting the operation data associated with the operation of the self-driving vehicle may involve: operating a sensing system at the self-driving vehicle to collect environmental data.

In some embodiments, determining the pre-condition period and the post-condition period may involve: determining a severity level of the trigger condition; and defining the pre-condition period and the post-condition period based on the severity level.

In some embodiments, determining the pre-condition period and the post-condition period may involve: determining the trigger condition includes the user-triggered condition; determining a user type of a user initiating the user-triggered condition; and defining the pre-condition period and the post-condition period based on the user type.

In some embodiments, determining the pre-condition period and the post-condition period may involve: determining one or more vehicle characteristics of the self-driving vehicle; and defining the pre-condition period and the post-condition period based on the one or more vehicle characteristics.

In some embodiments, the one or more vehicle characteristics may involve at least one of a vehicle type, a mission assigned to the self-driving vehicle, and a past operating record.

In some embodiments, the pre-condition period may include a different length of time than the post-condition period.

In some embodiments, the method may further involve: in response to receiving the subset of the operation data, operating a data analysis processor of the data analysis system to index the subset of the operation data based on a set of description identifiers stored in a database accessible by the data analysis processor.

In accordance with some embodiments, there is provided a non-transitory computer-readable medium including instructions executable on a processor for implementing the method.

In accordance with some embodiments, there is provided a system for monitoring an operation of one or more self-driving vehicles. The system includes a vehicle processor of a self-driving vehicle configured to: collect, during operation, operation data associated with the operation of the self-driving vehicle; detect, from the operation data, a trigger condition is satisfied during the operation; determine, for the trigger condition, a pre-condition period and a post-condition period during which a subset of the operation data is to be retrieved for analyzing the operation of the self-driving vehicle in respect of the trigger condition, the pre-condition period defining a time period before the trigger condition occurred and the post-condition period defining a time period following the trigger condition; retrieve, from a vehicle data storage, the subset of the operation data collected by the self-driving vehicle during the pre-condition period and the post-condition period; request a transmission policy from a data analysis system remote from the self-driving vehicle via a network, the transmission policy defining one or more transmission parameters for transmitting the subset of the operation data to the data analysis system; and transmit the subset of the operation data to the data analysis system according to the transmission policy.

In some embodiments, retrieving the subset of the operation data collected by the self-driving vehicle during the pre-condition period and the post-condition period may involve: associating the subset of the operation data with at least one description identifier related to the trigger condition.

In some embodiments, detecting the trigger condition is satisfied during the operation may involve: detecting at least one trigger condition of a plurality of trigger conditions is satisfied; and continuing to detect whether one or more other trigger conditions is satisfied.

In some embodiments, detecting the trigger condition is satisfied during the operation may involve: detecting, from the operation data, an error at the self-driving vehicle.

In some embodiments, detecting the error at the self-driving vehicle may involve: receiving at least two conflicting data inputs related to the operation of the self-driving vehicle.

In some embodiments, receiving the at least two conflicting data inputs may involve: receiving a first data input from a first sensor indicating a first condition; and receiving a second data input from a second sensor indicating a second condition opposite from the first condition.

In some embodiments, detecting the trigger condition is satisfied during the operation may involve: detecting, from the operation data, a completion of a mission assigned to the self-driving vehicle.

In some embodiments, detecting the trigger condition is satisfied during the operation may involve: detecting receipt of a user-triggered condition.

In some embodiments, detecting the trigger condition is satisfied during the operation may involve: detecting, from the operation data, a state change at the self-driving vehicle.

In some embodiments, the vehicle processor may be further configured to: determine an occurrence rate of the state change exceeds an occurrence threshold; and in response to determining the occurrence rate exceeds the occurrence threshold, initiate a cool-down period following the post-condition period during which the vehicle processor operates to retrieve and transmit a reduced subset of operation data as the subset of the operation data.

In some embodiments, collecting the operation data associated with the operation of the self-driving vehicle may involve: operating a sensing system at the self-driving vehicle to collect environmental data.

In some embodiments, determining the pre-condition period and the post-condition period may involve: determining a severity level of the trigger condition; and defining the pre-condition period and the post-condition period based on the severity level.

In some embodiments, determining the pre-condition period and the post-condition period may involve: determining the trigger condition includes the user-triggered condition; determining a user type of a user initiating the user-triggered condition; and defining the pre-condition period and the post-condition period based on the user type.

In some embodiments, determining the pre-condition period and the post-condition period may involve: determining one or more vehicle characteristics of the self-driving vehicle; and defining the pre-condition period and the post-condition period based on the one or more vehicle characteristics.

In some embodiments, the one or more vehicle characteristics may include at least one of a vehicle type, a mission assigned to the self-driving vehicle, and a past operating record.

In some embodiments, the pre-condition period may include a different length of time than the post-condition period.

In some embodiments, the vehicle processor may be further configured to: in response to receiving the subset of the operation data, operating a data analysis processor of the data analysis system to index the subset of the operation data based on a set of description identifiers stored in a database accessible by the data analysis processor.

In accordance with some embodiments, there is provided a method for monitoring an operation of one or more self-driving vehicles. The method involves operating a vehicle processor of a self-driving vehicle to: collect, during operation, operation data associated with the operation of the self-driving vehicle; detect, from the operation data, a trigger condition is satisfied during the operation; determine, for the trigger condition, a pre-condition period and a post-condition period during which a subset of the operation data is to be retrieved for an analysis of the operation of the self-driving vehicle in respect of the trigger condition, the pre-condition period defining a time period before the trigger condition occurred and the post-condition period defining a time period following the trigger condition; retrieve, from a vehicle data storage, the subset of the operation data collected by the self-driving vehicle during the pre-condition period and the post-condition period; and transmit the subset of the operation data to a data analysis system remote from the self-driving vehicle via a network to initiate an analysis of the operation of the self-driving vehicle in respect of the trigger condition.

In some embodiments, retrieving the subset of the operation data collected by the self-driving vehicle during the pre-condition period and the post-condition period may involve: associating the subset of the operation data with at least one description identifier related to the trigger condition.

In some embodiments, detecting the trigger condition is satisfied during the operation may involve: detecting at least one trigger condition of a plurality of trigger conditions is satisfied; and continuing to detect whether one or more other trigger conditions is satisfied.

In some embodiments, detecting the trigger condition is satisfied during the operation may involve: detecting, from the operation data, an error at the self-driving vehicle.

In some embodiments, detecting the error at the self-driving vehicle may involve: receiving at least two conflicting data inputs related to the operation of the self-driving vehicle.

In some embodiments, receiving the at least two conflicting data inputs may involve: receiving a first data input from a first sensor indicating a first condition; and receiving a second data input from a second sensor indicating a second condition opposite from the first condition.

In some embodiments, detecting the trigger condition is satisfied during the operation may involve: detecting, from the operation data, a completion of a mission assigned to the self-driving vehicle.

In some embodiments, detecting the trigger condition is satisfied during the operation may involve: detecting receipt of a user-triggered condition.

In some embodiments, detecting the trigger condition is satisfied during the operation may involve: detecting, from the operation data, a state change at the self-driving vehicle.

In some embodiments, the method may further involve operating the vehicle processor to: determine an occurrence rate of the state change exceeds an occurrence threshold; and in response to determining the occurrence rate exceeds the occurrence threshold, initiate a cool-down period following the post-condition period during which the vehicle processor operates to retrieve and transmit a reduced subset of operation data as the subset of the operation data.

In some embodiments, collecting the operation data associated with the operation of the self-driving vehicle may involve: operating a sensing system at the self-driving vehicle to collect environmental data.

In some embodiments, determining the pre-condition period and the post-condition period may involve: determining a severity level of the trigger condition; and defining the pre-condition period and the post-condition period based on the severity level.

In some embodiments, determining the pre-condition period and the post-condition period may involve: determining the trigger condition includes the user-triggered condition; determining a user type of a user initiating the user-triggered condition; and defining the pre-condition period and the post-condition period based on the user type.

In some embodiments, determining the pre-condition period and the post-condition period may involve: determining one or more vehicle characteristics of the self-driving vehicle; and defining the pre-condition period and the post-condition period based on the one or more vehicle characteristics.

In some embodiments, the one or more vehicle characteristics may include at least one of a vehicle type, a mission assigned to the self-driving vehicle, and a past operating record.

In some embodiments, the pre-condition period may include a different length of time than the post-condition period.

In some embodiments, the method may further involve: in response to receiving the subset of the operation data, operating a data analysis processor of the data analysis system to index the subset of the operation data based on a set of description identifiers stored in a database accessible by the data analysis processor.

In accordance with some embodiments, there is provided a non-transitory computer-readable medium including instructions executable on a processor for implementing the method.

In accordance with some embodiments, there is provided a system for monitoring an operation of one or more self-driving vehicles. The system includes a vehicle processor of a self-driving vehicle configured to: collect, during operation, operation data associated with the operation of the self-driving vehicle; detect, from the operation data, a trigger condition is satisfied during the operation; determine, for the trigger condition, a pre-condition period and a post-condition period during which a subset of the operation data is to be retrieved for an analysis of the operation of the self-driving vehicle in respect of the trigger condition, the pre-condition period defining a time period before the trigger condition occurred and the post-condition period defining a time period following the trigger condition; retrieve, from a vehicle data storage, the subset of the operation data collected by the self-driving vehicle during the pre-condition period and the post-condition period; and transmit the subset of the operation data to a data analysis system remote from the self-driving vehicle via a network to initiate an analysis of the operation of the self-driving vehicle in respect of the trigger condition.

In some embodiments, retrieving the subset of the operation data collected by the self-driving vehicle during the pre-condition period and the post-condition period may involve: associating the subset of the operation data with at least one description identifier related to the trigger condition.

In some embodiments, detecting the trigger condition is satisfied during the operation may involve: detecting at least one trigger condition of a plurality of trigger conditions is satisfied; and continuing to detect whether one or more other trigger conditions is satisfied.

In some embodiments, detecting the trigger condition is satisfied during the operation may involve: detecting, from the operation data, an error at the self-driving vehicle.

In some embodiments, detecting the error at the self-driving vehicle may involve: receiving at least two conflicting data inputs related to the operation of the self-driving vehicle.

In some embodiments, receiving the at least two conflicting data inputs may involve: receiving a first data input from a first sensor indicating a first condition; and receiving a second data input from a second sensor indicating a second condition opposite from the first condition.

In some embodiments, detecting the trigger condition is satisfied during the operation may involve: detecting, from the operation data, a completion of a mission assigned to the self-driving vehicle.

In some embodiments, detecting the trigger condition is satisfied during the operation may involve: detecting receipt of a user-triggered condition.

In some embodiments, detecting the trigger condition is satisfied during the operation may involve: detecting, from the operation data, a state change at the self-driving vehicle.

In some embodiments, the vehicle processor may be further configured to: determine an occurrence rate of the state change exceeds an occurrence threshold; and in response to determining the occurrence rate exceeds the occurrence threshold, initiate a cool-down period following the post-condition period during which the vehicle processor operates to retrieve and transmit a reduced subset of operation data as the subset of the operation data.

In some embodiments, collecting the operation data associated with the operation of the self-driving vehicle may involve: operating a sensing system at the self-driving vehicle to collect environmental data.

In some embodiments, determining the pre-condition period and the post-condition period may involve: determining a severity level of the trigger condition; and defining the pre-condition period and the post-condition period based on the severity level.

In some embodiments, determining the pre-condition period and the post-condition period may involve: determining the trigger condition includes the user-triggered condition; determining a user type of a user initiating the user-triggered condition; and defining the pre-condition period and the post-condition period based on the user type.

In some embodiments, determining the pre-condition period and the post-condition period may involve: determining one or more vehicle characteristics of the self-driving vehicle; and defining the pre-condition period and the post-condition period based on the one or more vehicle characteristics.

In some embodiments, the one or more vehicle characteristics may include at least one of a vehicle type, a mission assigned to the self-driving vehicle, and a past operating record.

In some embodiments, the pre-condition period may include a different length of time than the post-condition period.

In some embodiments, the vehicle processor may be further configured to: in response to receiving the subset of the operation data, operating a data analysis processor of the data analysis system to index the subset of the operation data based on a set of description identifiers stored in a database accessible by the data analysis processor.

In accordance with some embodiments, there is provided a method for monitoring an operation of one or more self-driving vehicles. The method involves: operating a vehicle processor of a self-driving vehicle to: collect a metric dataset and an operation dataset, the metric dataset comprising data related to one or more operating characteristics of the self-driving vehicle collected periodically and the operation dataset comprising data related to an operating state of the self-driving vehicle; periodically transmit the metric dataset to a data analysis system remote from the self-driving vehicle via a network; detect, from the operation dataset, a trigger condition is satisfied during the operation of the self-driving vehicle; determine, for the trigger condition, a pre-condition period and a post-condition period during which a subset of the operation data is to be retrieved for analyzing the operation of the self-driving vehicle in respect of the trigger condition, the pre-condition period defining a time period before the trigger condition occurred and the post-condition period defining a time period following the trigger condition; retrieve, from a vehicle data storage, the subset of the operation data collected by the self-driving vehicle during the pre-condition period and the post-condition period; request a transmission policy from the data analysis system via the network, the transmission policy defining one or more transmission parameters for transmitting the subset of the operation data to the data analysis system; and transmit the subset of the operation data to the data analysis system according to the transmission policy.

In some embodiments, retrieving the subset of the operation data collected by the self-driving vehicle during the pre-condition period and the post-condition period may involve: associating the subset of the operation data with at least one description identifier related to the trigger condition.

In some embodiments, detecting the trigger condition is satisfied during the operation may involve: detecting at least one trigger condition of a plurality of trigger conditions is satisfied; and continuing to detect whether one or more other trigger conditions is satisfied.

In some embodiments, detecting the trigger condition is satisfied during the operation may involve: detecting, from the operation data, an error at the self-driving vehicle.

In some embodiments, detecting the error at the self-driving vehicle may involve: receiving at least two conflicting data inputs related to the operation of the self-driving vehicle.

In some embodiments, receiving the at least two conflicting data inputs may involve: receiving a first data input from a first sensor indicating a first condition; and receiving a second data input from a second sensor indicating a second condition opposite from the first condition.

In some embodiments, detecting the trigger condition is satisfied during the operation may involve: detecting, from the operation data, a completion of a mission assigned to the self-driving vehicle.

In some embodiments, detecting the trigger condition is satisfied during the operation may involve: detecting receipt of a user-triggered condition.

In some embodiments, detecting the trigger condition is satisfied during the operation may involve: detecting, from the operation data, a state change at the self-driving vehicle.

In some embodiments, the method may further involve operating the vehicle processor to: determine an occurrence rate of the state change exceeds an occurrence threshold; and in response to determining the occurrence rate exceeds the occurrence threshold, initiate a cool-down period following the post-condition period during which the vehicle processor operates to retrieve and transmit a reduced subset of operation data as the subset of the operation data.

In some embodiments, collecting the operation data associated with the operation of the self-driving vehicle may involve: operating a sensing system at the self-driving vehicle to collect environmental data.

In some embodiments, determining the pre-condition period and the post-condition period may involve: determining a severity level of the trigger condition; and defining the pre-condition period and the post-condition period based on the severity level.

In some embodiments, determining the pre-condition period and the post-condition period may involve: determining the trigger condition includes the user-triggered condition; determining a user type of a user initiating the user-triggered condition; and defining the pre-condition period and the post-condition period based on the user type.

In some embodiments, determining the pre-condition period and the post-condition period may involve: determining one or more vehicle characteristics of the self-driving vehicle; and defining the pre-condition period and the post-condition period based on the one or more vehicle characteristics.

In some embodiments, the one or more vehicle characteristics may include at least one of a vehicle type, a mission assigned to the self-driving vehicle, and a past operating record.

In some embodiments, the pre-condition period may include a different length of time than the post-condition period.

In some embodiments, the method may further involve in response to receiving the subset of the operation data, operating a data analysis processor of the data analysis system to index the subset of the operation data based on a set of description identifiers stored in a database accessible by the data analysis processor.

In accordance with some embodiments, there is provided a non-transitory computer-readable medium including instructions executable on a processor for implementing the method.

In accordance with some embodiments, there is provided a system for monitoring an operation of one or more self-driving vehicles. The system includes a vehicle processor of a self-driving vehicle configured to: collect a metric dataset and an operation dataset, the metric dataset comprising data related to one or more operating characteristics of the self-driving vehicle collected periodically and the operation dataset comprising data related to an operating state of the self-driving vehicle; periodically transmit the metric dataset to a data analysis system remote from the self-driving vehicle via a network; detect, from the operation dataset, a trigger condition is satisfied during the operation of the self-driving vehicle; determine, for the trigger condition, a pre-condition period and a post-condition period during which a subset of the operation data is to be retrieved for analyzing the operation of the self-driving vehicle in respect of the trigger condition, the pre-condition period defining a time period before the trigger condition occurred and the post-condition period defining a time period following the trigger condition; retrieve, from a vehicle data storage, the subset of the operation data collected by the self-driving vehicle during the pre-condition period and the post-condition period; request a transmission policy from the data analysis system via the network, the transmission policy defining one or more transmission parameters for transmitting the subset of the operation data to the data analysis system; and transmit the subset of the operation data to the data analysis system according to the transmission policy.

In some embodiments, retrieving the subset of the operation data collected by the self-driving vehicle during the pre-condition period and the post-condition period may involve: associating the subset of the operation data with at least one description identifier related to the trigger condition.

In some embodiments, detecting the trigger condition is satisfied during the operation may involve: detecting at least one trigger condition of a plurality of trigger conditions is satisfied; and continuing to detect whether one or more other trigger conditions is satisfied.

In some embodiments, detecting the trigger condition is satisfied during the operation may involve: detecting, from the operation data, an error at the self-driving vehicle.

In some embodiments, detecting the error at the self-driving vehicle may involve: receiving at least two conflicting data inputs related to the operation of the self-driving vehicle.

In some embodiments, receiving the at least two conflicting data inputs may involve: receiving a first data input from a first sensor indicating a first condition; and receiving a second data input from a second sensor indicating a second condition opposite from the first condition.

In some embodiments, detecting the trigger condition is satisfied during the operation may involve: detecting, from the operation data, a completion of a mission assigned to the self-driving vehicle.

In some embodiments, detecting the trigger condition is satisfied during the operation may involve: detecting receipt of a user-triggered condition.

In some embodiments, detecting the trigger condition is satisfied during the operation may involve: detecting, from the operation data, a state change at the self-driving vehicle.

In some embodiments, the vehicle processor may be further configured to: determine an occurrence rate of the state change exceeds an occurrence threshold; and in response to determining the occurrence rate exceeds the occurrence threshold, initiate a cool-down period following the post-condition period during which the vehicle processor operates to retrieve and transmit a reduced subset of operation data as the subset of the operation data.

In some embodiments, collecting the operation data associated with the operation of the self-driving vehicle may involve: operating a sensing system at the self-driving vehicle to collect environmental data.

In some embodiments, determining the pre-condition period and the post-condition period may involve: determining a severity level of the trigger condition; and defining the pre-condition period and the post-condition period based on the severity level.

In some embodiments, determining the pre-condition period and the post-condition period may involve: determining the trigger condition includes the user-triggered condition; determining a user type of a user initiating the user-triggered condition; and defining the pre-condition period and the post-condition period based on the user type.

In some embodiments, determining the pre-condition period and the post-condition period may involve: determining one or more vehicle characteristics of the self-driving vehicle; and defining the pre-condition period and the post-condition period based on the one or more vehicle characteristics.

In some embodiments, the one or more vehicle characteristics may include at least one of a vehicle type, a mission assigned to the self-driving vehicle, and a past operating record.

In some embodiments, the pre-condition period may include a different length of time than the post-condition period.

In some embodiments, the vehicle processor may be further configured to: in response to receiving the subset of the operation data, operating a data analysis processor of the data analysis system to index the subset of the operation data based on a set of description identifiers stored in a database accessible by the data analysis processor.

### BRIEF DESCRIPTION OF THE DRAWINGS

Several embodiments will now be described in detail with reference to the drawings, in which:

FIG. 1 is a block diagram of example self-driving vehicles in communication with a data analysis system, according to at least one embodiment;

FIG. 2 is a block diagram of an example self-driving vehicle, according to at least one embodiment;

FIG. 3 is another block diagram of an example self-driving vehicle, according to at least one embodiment;

FIG. 4 is a flowchart illustrating an example method for monitoring an operation of one or more self-driving vehicles, according to at least one embodiment;

FIG. 5 is a graph illustrating data associated with an example operation of a self-driving vehicle, according to at least one embodiment;

FIG. 6 is a schematic illustrating an example operation of a self-driving vehicle according an example embodiment;

FIGS. 7A and 7B are graphs illustrating data associated with another example operation of a self-driving vehicle, according to at least one embodiment; and

FIG. 8 is a schematic illustrating another example operation of a self-driving vehicle according an example embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

A self-driving vehicle can include various sensors for sensing its environment. The various sensors can be used to facilitate autonomous navigation within the self-driving vehicle's environment with minimal to no human input. For example, a self-driving vehicle may use optical, RADAR, LIDAR, SONAR, GPS, odometry, or inertial measurement sensors, to perceive its surroundings. The sensor data can then be interpreted by the self-driving vehicle, a data analysis system and/or a fleet management system to identify obstacles and determine appropriate operation. The various sensors employed by a self-driving vehicle can produce large volumes of sensor data.

Self-driving vehicles can also generate large amounts of other data. For example, a self-driving vehicle may generate various data related to autonomous operation, such as an electronic map for navigation. The self-driving vehicle may also perform complex processing of the sensor data that results in the generation of additional data. The total volume of data generated by a self-driving vehicle can be very large. For example, some self-driving vehicles can generate data at a rate of more than 50 gigabytes per hour.

The data generated by a self-driving vehicle can be analyzed in order to monitor its operation. For example, in the event of a malfunction of a self-driving vehicle, the operation data of that self-driving vehicle can be analyzed to determine the cause of the malfunction. However, as the amount of data generated by a self-driving vehicle increases, it may become difficult to efficiently manage and analyze all of the operation data. This problem may be exacerbated in an industrial environment, where there may be many coordinated self-driving vehicles, each generating large volumes of operation data. Efficient management and analyses of large volumes of operation data may be required in order to monitor the operation of self-driving vehicles.

The embodiments described herein provide systems and methods for monitoring the operation of one or more self-driving vehicles. The described embodiments can facilitate the transmission of a subset of the data produced by a self-driving vehicle to a data analysis system. For example, as will be described in greater detail below, the self-driving vehicle can be triggered to transmit a subset of operation data collected during a time period before and after a trigger condition. Accordingly, the data analysis system can analyze the subset of data to monitor the operation of the self-driving vehicle, instead of analyzing the full set of data generated by the self-driving vehicle. The embodiments described herein can reduce the amount of data transmitted to the data analysis system while still providing relevant diagnostic feedback, and therefore reduce the amount of network bandwidth and computer resources expended by the data analysis system.

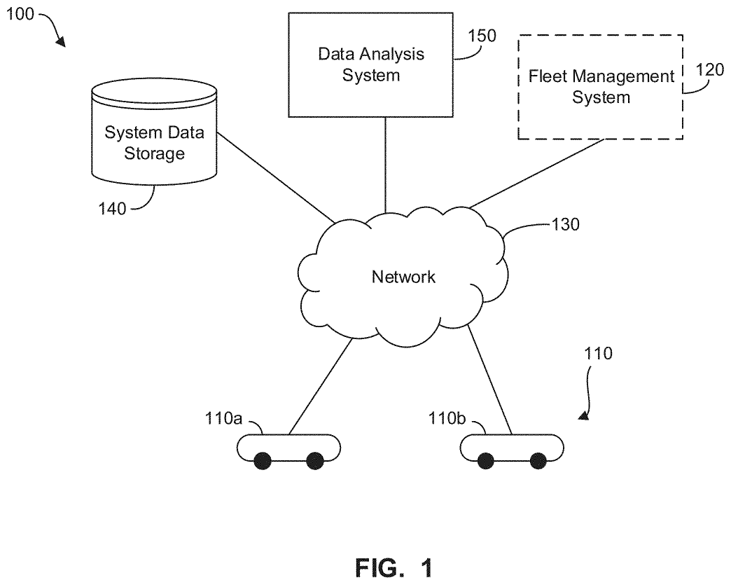

Reference is now made to FIG. 1, which shows a block diagram 100 illustrating example self-driving vehicles 110a, 110b (collectively referred to as the self-driving vehicles 110) in communication with a data analysis system 150, a system data storage 140, and, optionally, a fleet management system 120, via a network 130. While FIG. 1 shows example vehicles 110a, 110b for illustrative purposes, fewer or more self-driving vehicles 110 can operate with the fleet management system 120. In some embodiments, the fleet management system 120 may perform one or more functions of the data analysis system 150 so that a separate data analysis system 150 may not be required. In some embodiments, the fleet management system 120 may perform one or more functions of the data analysis system 150 in parallel with another data analysis system 150.

The network 130 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between the self-driving vehicles 110, the data analysis system 150, the system data storage 140, and/or the fleet management system 120. In some embodiments, the self-driving vehicles 110 can communicate with each other via the network 130. For example, vehicle 110a can communicate with vehicle 110b via the network 130. In some embodiments, vehicle 110a can communicate with vehicle 110b directly via onboard communication components.

The system data storage 140 can store data related to the self-driving vehicles 110, the data analysis system 150, and/or the fleet management system 120. The system data storage 140 can include RAM, ROM, one or more hard drives, one or more flash drives or some other suitable data storage elements such as disk drives, etc. In some embodiments, the system data storage 140 can be located at the data analysis system 120 and/or the data analysis system 150.

For example, the system data storage 140 can store electronic maps related to the operating environment of the self-driving vehicles 110. The electronic maps located on system data storage 140 can be accessible for download, via the network 130, by the fleet management system 120 and/or the self-driving vehicles 110.

The fleet management system 120 can operate to direct and/or monitor the operation of the self-driving vehicles 110. In some embodiments, the self-driving vehicles 110 can operate within a decentralized network—without, or at least with minimal, involvement of the fleet management system 120.

The fleet management system 120 can include a processor, a data storage, and a communication component (not shown). For example, the fleet management system 120 can be any computing device, such as, but not limited to, an electronic tablet device, a personal computer, workstation, server, portable computer, mobile device, personal digital assistant, laptop, smart phone, WAP phone, an interactive television, video display terminals, gaming consoles, and portable electronic devices or any combination of these. The components of the fleet management system 120 can be provided over a wide geographic area and in communication via the network 130.

The processor of the fleet management system 120 can include any suitable processors, controllers or digital signal processors that can provide sufficient processing power depending on the configuration, purposes and requirements of the fleet management system 120. In some embodiments, the processor can include more than one processor with each processor being configured to perform different dedicated tasks.

The data storage of the fleet management system 120 can include random access memory (RAM), a read-only memory (ROM), an erasable programmable read-only memory (EPROM, EEPROM, or Flash memory), one or more hard drives, one or more flash drives or some other suitable data storage elements such as disk drives, etc. The communication component of the fleet management system 120 can include any interface that enables the fleet management system 120 to communicate with other devices and systems. In some embodiments, the communication component can include at least one of a serial port, a parallel port or a USB port. The communication component may also include at least one of an Internet, Local Area Network (LAN), Ethernet, Firewire, modem or digital subscriber line connection. Various combinations of these elements may be incorporated within the communication component. For example, the communication component may receive input from various input devices, such as a mouse, a keyboard, a touch screen, a thumbwheel, a track-pad, a track-ball, a card-reader, voice recognition software and the like depending on the requirements and implementation of the fleet management system 120.

In some embodiments, the fleet management system 120 can generate commands for the self-driving vehicles 110. For example, the fleet management system 120 can generate and transmit navigational commands to the self-driving vehicles 110. The navigational commands can direct the self-driving vehicles 110 to navigate to one or more destination locations located within the operating environment of the self-driving vehicles 110. For example, the destination locations can correspond to locations where the self-driving vehicles 110 are required to pick up or drop off loads.

In some embodiments, the fleet management system 120 can transmit only the destination locations to the self-driving vehicles 110 and the self-driving vehicles 110 can then navigate themselves to the destination locations. The fleet management system 120 can transmit the destination locations in various formats, such as, but not limited to, a set of Global Positioning System (GPS) coordinates, or coordinates defined relative to an electronic map accessible to the self-driving vehicles 110 and the fleet management system 120. The destination locations, in some embodiments, can be identified with respect to known objects or landmarks within the operating environment of the self-driving vehicles 110. For example, the self-driving vehicles 110 can identify the location of the object or landmark on an electronic map, and navigate to the object or landmark.

The fleet management system 120 can also transmit action commands to the self-driving vehicles 110. Action commands can define an action that the self-driving vehicles 110 are required to perform at a destination location, for example. An example action command can indicate that the self-driving vehicles 110a is to pick up a load at a first destination location, and drop off the load at a second destination location. When the action command requires the self-driving vehicles 110a to pick up a load, the fleet management system 120 can include information about the load within the action command, such as image data or text data associated with the load. The image data can include an image of the load and the text data can include load descriptions, such as dimensions, color, size, and/or weight. The image and text data can assist the self-driving vehicles 110 with identifying the load.

In some embodiments, one or more commands for the self-driving vehicles 110 generated by the fleet management system 120 may be referred to as a mission.

In some embodiments, the fleet management system 120 can perform the functions of the data analysis system 150 so that the data analysis system 150 does not need to be provided separately.

The data analysis system 150 can include a processor, a data storage, and a communication component (not shown). For example, the data analysis system 150 can be any computing device, such as, but not limited to, an electronic tablet device, a personal computer, workstation, server, portable computer, mobile device, personal digital assistant, laptop, smart phone, WAP phone, an interactive television, video display terminals, gaming consoles, and portable electronic devices or any combination of these. The components of the data analysis system 150 can be provided over a wide geographic area and in communication via the network 130.

The processor of the data analysis system 150 can include any suitable processors, controllers or digital signal processors that can provide sufficient processing power depending on the configuration, purposes and requirements of the data analysis system 150. In some embodiments, the processor can include more than one processor with each processor being configured to perform different dedicated tasks.

The data storage of the data analysis system 150 can include random access memory (RAM), a read-only memory (ROM), an erasable programmable read-only memory (EPROM, EEPROM, or Flash memory), one or more hard drives, one or more flash drives or some other suitable data storage elements such as disk drives, etc. The communication component of the data analysis system 150 can include any interface that enables the data analysis system 150 to communicate with other devices and systems. In some embodiments, the communication component can include at least one of a serial port, a parallel port or a USB port. The communication component may also include at least one of an Internet, Local Area Network (LAN), Ethernet, Firewire, modem or digital subscriber line connection. Various combinations of these elements may be incorporated within the communication component. For example, the communication component may receive input from various input devices, such as a mouse, a keyboard, a touch screen, a thumbwheel, a track-pad, a track-ball, a card-reader, voice recognition software and the like depending on the requirements and implementation of the data analysis system 150.

The data analysis system 150 can receive data from the self-driving vehicles 110 and/or the fleet management system 120. In some embodiments, the data analysis system 150 may receive operation data from the self-driving vehicles 110 via the fleet management system 120. As will be described in further detail below, the data analysis system 150 can perform various analyses on operation data received from the self-driving vehicles 110 and/or the fleet management system 120. It should be appreciated that, in some embodiments, the fleet management system 120 may perform one or more functions of the data analysis system 150.

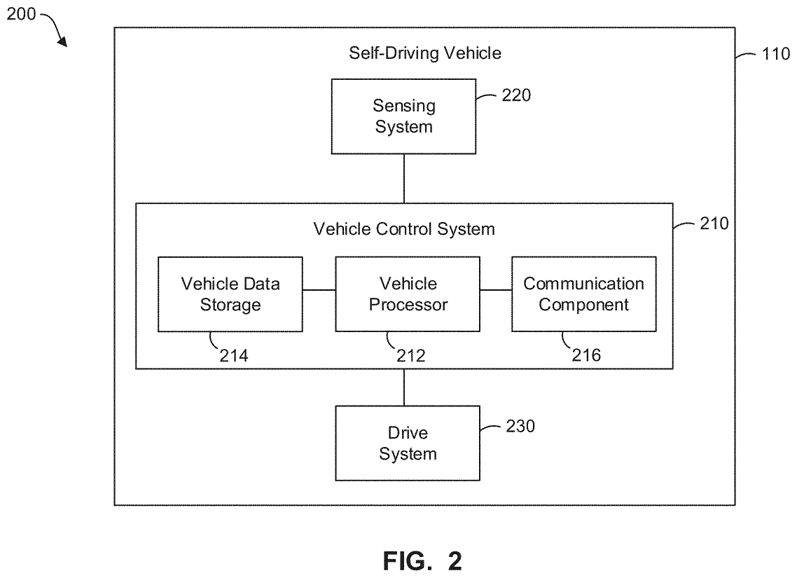

Reference is now made to FIG. 2, which illustrates a block diagram 200 of an example self-driving vehicle 110. The self-driving vehicle 110 can include a vehicle control system 210, a sensing system 220, and a drive system 230. The vehicle control system 210 includes a vehicle processor 212, a vehicle data storage 214, and a communication component 216. Components 210, 212, 214, 216, 220, and 230 are illustrated separately in FIG. 2, for ease of exposition. In some embodiments, one or more of the components 210, 212, 214, 216, 220, and 230 can be combined into fewer components, or separated into further components. In some embodiments, parts of a component can be combined with another part of another component.

The vehicle processor 212 can include any suitable processor, controller or digital signal processor that can provide sufficient processing power depending on the configuration, purposes and requirements of the self-driving vehicle 110. In some embodiments, the vehicle processor 212 can include more than one processor with each processor being configured to perform different dedicated tasks.

The vehicle processor 212 can operate the vehicle data storage 214, the communication component 216, the sensing system 220, and the drive system 230. For example, the vehicle processor 212 can operate the drive system 230 to navigate to the destination location as identified by the fleet management system 120. The vehicle processor 212 can also control the vehicle data storage 214, the communication component 216, the sensing system 220, and the drive system 230, as necessary, to implement the action commands received from the fleet management system 120. The operation of the vehicle processor 212 can be based on data collected from the vehicle data storage 214, the communication component 216, the sensing system 220, and/or the drive system 230, in some embodiments. The vehicle processor 212 can operate to process data received from the sensing system 220.

The vehicle data storage 214 can include can include RAM, ROM, one or more hard drives, one or more flash drives or some other suitable data storage elements such as disk drives, etc. For example, the vehicle data storage 214 can include volatile and non-volatile memory. Non-volatile memory can store computer programs consisting of computer-executable instructions, which can be loaded into the volatile memory for execution by the vehicle processor 212. Operating the vehicle processor 212 to carry out a function can involve executing instructions (e.g., a software program) that can be stored in the vehicle data storage 214 and/or transmitting or receiving inputs and outputs via the communication component 216. The vehicle data storage 214 can also store data input to, or output from, the vehicle processor 212, which can result from the course of executing the computer-executable instructions for example.

In some embodiments, the vehicle data storage 214 can store data related to the operation of the self-driving vehicle 110, such as one or more electronic maps of its operating environment and/or operating parameters. The vehicle data storage 214 can store data tables, data processing algorithms (e.g., image processing algorithms), as well as other data and/or operating instructions which can be used by the vehicle processor 212.

The communication component 216 can include any interface that enables the self-driving vehicle 110 to communicate with other components, and external devices and systems. In some embodiments, the communication component 216 can include at least one of a serial port, a parallel port or a USB port. The communication component 216 may also include a wireless transmitter, receiver, or transceiver for communicating with a wireless communications network (e.g. using an IEEE 802.11 protocol or similar). The wireless communications network can include at least one of an Internet, Local Area Network (LAN), Ethernet, Firewire, modem or digital subscriber line connection. Various combinations of these elements may be incorporated within the communication component 216. For example, the communication component 216 may receive input from various input devices, such as a mouse, a keyboard, a touch screen, a thumbwheel, a track-pad, a track-ball, a card-reader, voice recognition software and the like depending on the requirements and implementation of the self-driving vehicle 110. For example, the communication component 216 can receive commands and/or data from the fleet management system 120, the data analysis system 150, and/or another autonomous vehicle (e.g., another autonomous vehicle operating within the operating environment).

The communication component 216 can receive information about obstacles and/or unexpected objects located in the vehicle's operating environment directly from other autonomous vehicles within the same operating environment and/or indirectly via the fleet management system 120. The vehicle processor 212 may also transmit, via the communication component 216 for example, information related to obstacles and/or unexpected objects identified in its operating environment to other autonomous vehicles directly or indirectly via the fleet management system 120.

The sensing system 220 can monitor the environment of the self-driving vehicle 110. The sensing system 220 can include one or more sensors for capturing information related to the environment. The information captured by the sensing system 220 can be applied for various purposes, such as, but not limited to, localization, navigation and/or mapping. For example, the sensing system 220 can include, but not limited to, optical sensors equipped with depth perception capabilities, infrared (IR) capabilities, or sonar capabilities. The optical sensors can include imaging sensors (e.g., photographic and/or video cameras), and range-finding sensors (e.g., time of flight sensors, Light Detection and Ranging (LIDAR) devices which generate and detect reflections of pulsed laser from objects proximal to the self-driving vehicle 110, etc.). The sensing system 220 can also include navigational sensors, such as ground positioning system (GPS) sensors, as well as sensors that detect guiding infrastructure installed within the operating environment. Example sensors that detect guiding infrastructure can include, but not limited to, magnetic sensors that detect magnetic tape within a facility warehouse, and/or optical sensors that detect visual navigational indicators within the operating environment.

The sensing system 220 can also include one or more sensors for monitoring the various components and subcomponents of the self-driving vehicle 110. In some embodiments, the sensing system can monitor the vehicle control system 210, the drive system 230, and/or subcomponents thereof. For example, the sensing system 220 may include, but is not limited to, sensors for measuring voltage, current, velocity, acceleration, and/or temperature.

In some embodiments, the sensing system 220 can include a sensing processor that receives data collected by the sensors and processes the collected data. The sensing processor can operate independently from the vehicle processor 212. In some other embodiments, the sensing system 220 can receive the data collected by the sensors and transmit the collected data to the vehicle processor 212 for further processing.

The vehicle processor 212 can receive the data collected by the sensing system 220, and can apply the collected data to assist with navigating the self-driving vehicle 110 within its operating environment. For example, the vehicle processor 212 can receive environment data from the sensing system 220 in respect of the environment (e.g., a landmark) and can cross-reference the received environment data against the electronic map to assist with localizing the self-driving vehicle 110 and to navigate the self-driving vehicle 110 accordingly. The vehicle processor 212 can also use data collected by the sensing system 220 to determine locations for load pick-up and drop-off. For example, the sensing system 220 can collect data related to visual markers associated with pick-up and drop-off locations. The sensing system 220 can then transmit the collected data to the vehicle processor 212 for processing, or can determine the associated location before transmitting the location data to the vehicle processor 212. Example visual indicators can include, but not limited to, corner tape or graphic patterns placed on the ground for identifying the pick-up or drop-off location. In some examples, the sensing system 220 can include optical sensors and/or LIDAR sensors operable for detecting the visual indicators.

The sensing system 220 can also assist the vehicle processor 212 with executing action commands, such as those received from the fleet management system 120. For example, when executing the action command related to a load pick-up, the sensing system 220 can operate to collect image data related to the environment of the self-driving vehicle 110 to assist the vehicle processor 212 with identifying the load and orienting with respect to the load for the pick-up.

In some embodiments, the sensing system 220 can be operated to monitor the operating environment of the self-driving vehicle 110 for the purpose of minimizing and/or avoiding collisions.

The sensing system 220 can include sensors dedicated for collision avoidance, in some embodiments, or can use existing sensors within the sensing system 220 for collision avoidance. In contrast with sensor data required for localization, navigation and/or mapping, the sensor data required for collision avoidance can be lower resolution. For example, sensors such as LIDAR devices and time-of-flight sensors can generate robust signals that can be quickly transmitted and processed, which can be important for collision avoidance. In some embodiments, the vehicle processor 212 can use the data collected from the sensing system 220 for avoidance detection, even though the sensor data may be higher-resolution and requires more processing time.

The vehicle processor 212 can operate the sensing system 220 to detect an obstacle within the operating environment. In response to detecting the obstacle, the vehicle processor 212 can implement a collision avoidance operation to minimize, or prevent, a collision between the self-driving vehicle 110 and the detected obstacle. Examples of collision avoidance operations can include, but not limited to, controlling the drive system 230 to immediately stop the vehicle, cutting power to the vehicle motor, or avoidance steering.

The sensing system 220 can also include the sensing processor, in some embodiments, to assist with collision avoidance. For example, the sensing processor can receive data collected by the sensors to determine whether a collision is imminent and operate one or more collision avoidance operations. The sensing processor can include a low-level processor, such as a programmable logic controller (PLC). The sensing processor can receive and process low-level signals generated by the sensors, and in turn, can transmit low-level output logic signals to control the drive system 230 to implement a collision avoidance operation. With a low-level processor, the time required for detecting the collision can be improved to facilitate quick responses (in contrast to the vehicle processor 212, which is a more complex processor as it needs to execute instructions related to autonomous navigation and other operations).

The drive system 230 can include the components required for steering and driving the self-driving vehicle 110. For example, the drive system 230 can include a steering component and a drive motor.

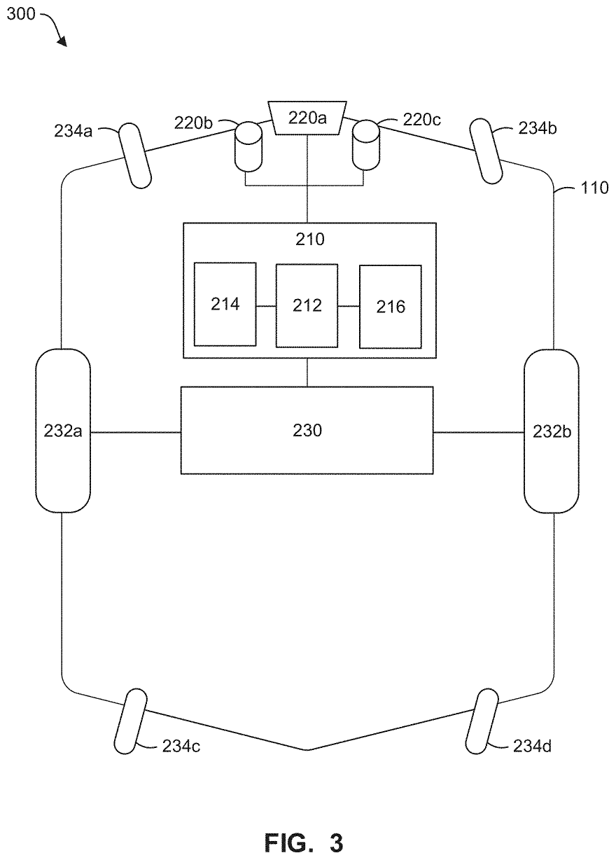

Reference will now be made to FIG. 3, which is another block diagram 300 of an example self-driving vehicle 110. The self-driving vehicle 110 includes the vehicle control system 210, the sensing system 220, and the drive system 230.

The drive system 230 can include a motor and/or brakes connected to drive wheels 232a and 232b for driving the self-driving vehicle 110. According to some embodiments, the motor may be an electric motor, a combustion engine, or a combination/hybrid thereof. In some embodiments, the drive system can include a battery for powering the motor. Depending on the particular embodiment, the drive system 230 may also include control interfaces that can be used for controlling the drive system 230. For example, the drive system 230 may be controlled to drive the drive wheel 232a at a different speed than the drive wheel 232b in order to turn the self-driving vehicle 110. Different embodiments may use different numbers of drive wheels, such as two, three, four, etc.

The drive system 230 can also include additional wheels 234a, 234b, 234c, and 234d (collectively referred herein as the wheels 234). Any or all of the additional wheels 234 may be wheels that are capable of allowing the self-driving vehicle 110 to turn, such as castors, omni-directional wheels, and mecanum wheels.

The sensing system 220 can include a sensor 220a for detecting obstacles and optical sensors 220b, 220c. Example sensors 220a for detecting obstacles can include LIDAR devices or time-of-flight sensors. As shown in FIG. 3, the sensor 220a can be located at the front-end of the self-driving vehicle 110. At this location, the sensor 220a can scan for objects that may enter the path of the self-driving vehicle 110. More sensors 220a can be mounted to the self-driving vehicle 110, in some embodiments. The sensors 220a can be mounted to different locations, such as the front corner of the self-driving vehicle 110. Optical sensors 220b, 220c can include imaging and/or video cameras, mounted to a forward portion of the self-driving vehicle 110. According to some embodiments, the sensing system can include optical sensors arranged in a manner to provide three-dimensional (e.g. binocular or RGB-D) imaging.

The vehicle control system 210 can operate, at least, the drive system 230 and the sensing system 220 and can control and receive information from these components.

The positions of the components 210, 212, 214, 216, 220, 230, 232, and 234 of the self-driving vehicle 110 are shown for illustrative purposes and are not limited to the shown positions. Other configurations of the components 210, 212, 214, 216, 220, 230, 232, and 234 are possible.

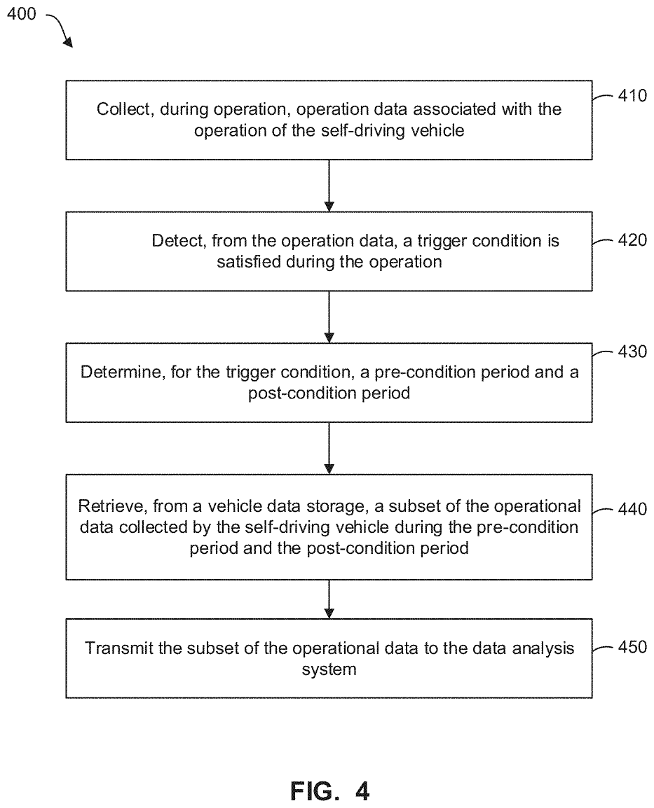

Referring now to FIG. 4, there is shown an example method 400 for monitoring an operation of one or more self-driving vehicles 110.

The method 400 begins at 410, where a vehicle processor 212 of the self-driving vehicle 110 collects, during the operation, operation data associated with the operation of the self-driving vehicle 110. The operation data can be collected from a variety of sources and can include any data related to the operating state of the self-driving vehicle 110.

The operation data may include data related to the environment of the self-driving vehicle 110. The vehicle processor 212 may operate the sensing system 220 to collect environmental data. For example, the vehicle processor 212 can collect obstacle data from obstacle detecting sensors 220a or imaging data from optical sensors 220b, 220c. For instance, the vehicle processor can collect data regarding the velocity, distance, or position of obstacles, or images and videos of the surroundings of the self-driving vehicle 110.

The operation data can also include data related to the self-driving vehicle 110 itself. The vehicle processor 212 can collect vehicle data from the sensing system 220. For example, the vehicle processor 212 can collect data regarding the temperature, supplied current, supplied voltage, velocity, or acceleration of one or more components of the drive system 230. The vehicle processor 212 may also collect vehicle data directly from the components and subcomponents of the self-driving vehicle 110. For example, the vehicle processor 212 can collect log files, command signals, messages, and other data from the drive system 230 or control system 210. The log files and other data may contain various information related to the autonomous navigation and other operations of the self-driving vehicle.

The operation data can include data that has been processed, for example by the vehicle processor 212 or a sensing processor (not shown), or raw data that has not been processed. The vehicle processor 212 can store the collected operation data in the vehicle data storage 214. As will be described below, the collected operation data can be transmitted to the data analysis system 150, which can analyze the operation data to monitor the operation of the self-driving vehicle 110.

In some embodiments, the vehicle processor 212 can also collect a metric dataset, in addition to the operation data, or a set of operation data (“operation dataset”). The metric dataset includes data related to one or more operating characteristics of the self-driving vehicle 110. The operating characteristics can include any characteristic related to the operation of the self-driving vehicle 110. The metric dataset can also be collected by the vehicle processor 112 from one or more components of the self-driving vehicle 110, such as the vehicle control system 210, the sensing system 220, or the drive system 230. The metric dataset can include data that is also included in the operation dataset. However, as will be described below, the metric dataset typically includes a smaller quantity of data than the operation dataset.

The vehicle processor 212 collects the data for the metric dataset periodically. The frequency of the data collection for the metric dataset can vary with various factors, such as a preferred amount of metric dataset and a variability in the system. For example, the vehicle processor 212 may collect data more often in order to yield a larger overall metric dataset. In another example, for a system in which the self-driving vehicle 110, and/or the environment is unlikely to experience changes often, a lower frequency of data collection may be appropriate.

In some embodiments, the data collection frequency for the metric dataset is slower than the rate at which data is generated by the self-driving vehicle 110. Accordingly, the vehicle processor 212 may not collect all of the available data for a particular operating characteristic for the metric dataset. For example, obstacle detecting sensor 220a may generate an obstacle distance every millisecond, whereas the vehicle processor 212 may only collect the obstacle distances generated at each minute mark for the metric dataset. In other embodiments, the vehicle processor 212 may collect all of the available data for a particular operating characteristic, but only designate some of the available data as part of the metric dataset. For example, the vehicle processor 212 may generate a mean, median, or mode of some of the data to include in the metric dataset. For instance, the vehicle processor 212 may collect each obstacle distance from the obstacle detecting sensor 220a every millisecond, but only include an average of the obstacle distances in the metric dataset for every minute. Accordingly, the size of the metric dataset can be significantly smaller than the size of the operation dataset.

The vehicle processor 212 can store the metric dataset in the vehicle data storage 214. The vehicle processor 212 can periodically transmit the metric dataset to the data analysis system 150. The size of the metric dataset can be sufficiently small so that it can be frequently transmitted to the data analysis system 150.

In contrast, the operation dataset is typically larger than the metric dataset and is not periodically transmitted to the data analysis system 150. Instead, as will be described in further detail below, the vehicle processor 212 transmits a subset of the operation dataset, upon detection that a trigger condition is satisfied. The operational dataset is typically more comprehensive than the metric dataset, but is not automatically, periodically transmitted to the data analysis system 150.

Both the metric dataset and the operation dataset can be analyzed by the data analysis system 150. However, the analysis of the metric dataset can provide different insights regarding the operation of the self-driving vehicle 110 than the analysis of the operation dataset since the operation dataset is transmitted to the data analysis system 150 upon the detection of a trigger condition. Accordingly, operation of the self-driving vehicle 110 that does not cause a trigger condition to be satisfied can nevertheless be analyzed using the metric dataset.

For example, during a particular mission, the drive system 230 of the self-driving vehicle 110 may operate at an undesirable high average temperature. However, the instantaneous temperature of the drive system 230 may not be sufficiently high to cause a trigger condition to be satisfied (e.g., where the trigger condition corresponds to a predefined maximum temperature of the drive system 230 that is unsafe for operation). The undesirable high average temperature of the drive system 230 can be analyzed by the data analysis system 150 through the collection and transmission of the metric dataset.

At step 420, the vehicle processor 212 detects, from the operation data, that a trigger condition is satisfied during the operation. After detecting the trigger condition is satisfied, the vehicle processor 212 can continue to detect whether one or more other trigger conditions are satisfied. As will be described, when the vehicle processor 212 detects a trigger condition is satisfied, the vehicle processor 212 can be triggered to transmit a subset of the operation data to the data analysis system 150. Various trigger conditions can be satisfied and detected by the vehicle processor 212.

In some embodiments, the trigger condition can correspond to an error at the self-driving vehicle 110. That is, the vehicle processor 212 can detect a trigger condition is satisfied by detecting an error at the self-driving vehicle 110. Various errors can cause the vehicle processor 212 to detect that a trigger condition to be satisfied. For example, the error may involve a failure of one or more components of the self-driving vehicle 110, for instance resulting in an emergency stop of the self-driving vehicle 110, a collision of the self-driving vehicle 110 with an obstacle, and/or an unexpected obstacle in the environment. The error may involve the self-driving vehicle 110 getting stuck, losing traction, or losing control of the drive system 230. The error may involve a communication error between the self-driving vehicle 110 and the network 130, or between two or more of the components of the self-driving vehicle 110. The error may involve a lost localization of the self-driving vehicle 110. For example, the self-driving vehicle 110 may have a map, such as an electronic map, stored internal but the map may not be currently updated. The self-driving vehicle may then lose their current location.

The vehicle processor 212 can detect the error in various ways. In some embodiments, the vehicle processor 212 can detect the error based on one or more data inputs related to the operation of the self-driving vehicle 110, such as, from the operation data. For example, the vehicle processor 212 can receive at least two conflicting data inputs related to the operation of the self-driving vehicle 110. The vehicle processor 212 may receive a first data input from a first sensor indicating a first condition and a second data input from a second sensor indicating a second condition opposite from the first condition. For instance, the vehicle processor 212 may receive range data (e.g., defining a distance between the self-driving vehicle 110 and one or more obstacles) from obstacle detection sensor 220a and receive image data from optical sensor 220b. The range data and the image data can each indicate a distance to an obstacle in the path of the self-driving vehicle 110. The distance indicated by the range data may be different from the range indicated by the image data, causing an error to be detected by vehicle processor 212. For example, one of the obstacle detection sensor 220a and the optical sensor 220b may be obstructed resulting in inaccurate sensor readings.

In some embodiments, the trigger condition may be a completion of a mission assigned to the self-driving vehicle 110. That is, detecting the trigger condition is satisfied can involve the vehicle processor 212 detecting the completion of a mission assigned to the self-driving vehicle 110. For example, the self-driving vehicle may be assigned a mission to pick up a load at a first destination location, and drop off that load at a second destination location. The vehicle processor 212 can determine that the load has been dropped off at the second destination location, indicating that the mission is complete.

The trigger condition may also include a user-triggered condition. That is, the vehicle processor 212 can detect the trigger condition is satisfied by detecting the receipt of a user-triggered condition. For example, a user may wish to manually trigger the transmission of a subset of the collected operation data to the data analysis system 150. The user can send a request to the self-driving vehicle 110 via the network 130 to cause the user-triggered condition. For instance, the user may notice an unusual or unexpected action of the self-driving vehicle 110. For example, the user may observe the self-driving vehicle 110 slipping while in operation. In order to investigate the unusual or unexpected action, the user can submit a request and cause the user-triggered condition. For example, the user can transmit a request using a computing device via the network 130 to the data analysis system 150.

The trigger condition may also correspond to a state change at the self-driving vehicle 110. That is, the vehicle processor 212 can detect the trigger condition is satisfied by detecting a state change at the self-driving vehicle 110. For example, the vehicle processor 212 may detect that the temperature of a component of the self-driving vehicle 110 has exceeded a safety threshold. In another example, the vehicle processor 212 may detect that the velocity of a wheel 232 is indicative of a loss of traction.

In some embodiments, the vehicle processor 212 can monitor an occurrence rate of the state change at the self-driving vehicle 110. The vehicle processor 212 can determine that an occurrence rate of the state change exceeds an occurrence threshold. The vehicle processor 212 can then initiate a cool-down period following a post-condition period during which the vehicle processor 212 operates to retrieve and transmit a reduced subset of operation data as the subset of the operation data. The reduced subset of operation data is a subset of the operation data normally retrieved and transmitted by the vehicle processor 212.

For example, the vehicle processor 212 may detect that a temperature of a component of the self-driving vehicle 110 has exceeded a safety threshold during operation. The detection of the temperature exceeding the safety threshold can trigger the transmission of a subset of operation data to the data analysis system 150. However, the continued operation of the self-driving vehicle 110 may continue to cause the temperature of the component to exceed the safety threshold. In order to prevent repeated transmission of similar operation data, the vehicle processor 212 can initiate a cool-down period during which the vehicle processor 212 retrieves and transmits a reduced subset of the collected operation data. For instance, the reduced subset may only include data relevant to the subsequent triggers or data that has changed significantly from the previous transmission. For example, the vehicle processor 212 may continue to transmit temperature data, but may not transmit data unrelated to the excess temperature, such as the velocity of the self-driving vehicle 110. However, if the velocity of the vehicle 110 has changed significantly from the previous transmission, it may still be included by the vehicle processor 212.

At step 430, the vehicle processor 212 determines, for the trigger condition, a pre-condition period and a post-condition period. The pre-condition period defines a time period before the trigger condition occurs. Similarly, the post-condition period defines a time period after the trigger condition occurs. Accordingly, the pre-condition period and the post-condition period may collectively define a time period that includes: (i) a time before the trigger condition occurred, (ii) a time at which the trigger condition occurred, and (iii) a time after the trigger condition occurred.

A subset of the operation data collected by the vehicle processor 212 at step 410 is collected during either the pre-condition period or the post-condition period. As will be described in greater detail below, the vehicle processor 212 can retrieve and transmit the subset of the operation data to the data analysis system 150. The data analysis system 150 can then analyze the subset of operation data. Since the subset of operation data is collected in one of two time periods corresponding to the trigger condition, the data analysis system 150 can analyze the operation of the self-driving vehicle with respect to the trigger condition. For example, continuing with the example of the trigger condition corresponding to an excess temperature of one of the components of the self-driving vehicle 110, the data analysis system 150 can analyze the operation of the self-driving vehicle before, during, and after the occurrence of the excess temperature condition to determine the cause of the excess temperature condition.

Each of the pre-condition period and the post-condition period can have different start and end times, and different resulting durations. For example, in some embodiments, the pre-condition period has a different length of time than the post-condition period, while in other embodiments, the pre-condition period has the same length of time as the post-condition period.

The vehicle processor 212 can determine the pre-condition period and the post-condition period for the trigger condition in various ways. In some embodiments, the vehicle processor 212 can determine a severity level of the trigger condition and define the pre-condition and post-condition period based on the severity level. For example, continuing with the example where the trigger condition corresponds to a collision of the self-driving vehicle 110, the vehicle processor 212 can determine a severity level of the collision. For instance, the vehicle processor 212 may determine a relatively longer pre-condition or post-condition period for a severe collision, such as a collision that damages the drive system 230 of the self-driving vehicle 110, whereas the vehicle processor 212 may determine a relatively shorter pre-condition or post-condition period for a less severe collision, such as a collision involving only cosmetic damage to the self-driving vehicle 110.

The vehicle processor 212 can also determine one or more vehicle characteristics of the self-driving vehicle and define the pre-condition and post-condition period based on the one or more vehicle characteristics. The vehicle characteristics can include any characteristics related to the self-driving vehicle 110. For example, the vehicle characteristics can include a vehicle type, a mission assigned to the self-driving vehicle 110, and a past operating record.

Different types of self-driving vehicles 110 can correspond to varying degrees of hardware and software complexity, which can affect the amount of operation data that is desired when a trigger condition is satisfied. Similarly, different types of missions may be associated with different levels of risk. For some routine missions, very little operation data may be desired, whereas a larger amount of operation data may be desired for riskier (e.g., experimental) missions. Likewise, the past operating record of a self-driving vehicle 110 may indicate that more operation data should be requested for a less reliable vehicle, while less operation data should be requested for a more reliable vehicle.

In some embodiments, the vehicle processor 212 can determine the trigger condition includes a user-triggered condition, determine a user type for the user initiating the user-triggered condition, and define the pre-condition period and the post-condition period based on the user type. As noted above, the trigger condition can correspond to a manual request initiated by a user. In these embodiments, the type of user may affect the pre-condition and post-condition period. For example, a user type can define a level of user corresponding to a desired amount of operation data. For instance, a standard user may wish to receive a basic or limited dataset, whereas an administrative or advanced user may wish for a more complete operation dataset for analysis. The basic dataset may include a subset of the operation data that is relevant the user, for example only including data related to the drive system 230.

At step 440, the vehicle processor 212 retrieves, from the vehicle data storage 214, the subset of the operation data collected by the self-driving vehicle 110 during the pre-condition period and the post-condition period.

In some embodiments, the vehicle processor 212 can associate the subset of the operation data with at least one description identifier related to the trigger condition. For example, the vehicle processor 212 may append a descriptive tag to the operation data, such as “high temperature: engine” or “loss of traction: left wheel”. It will be understood that these are simply example descriptive tags and that other formats can be used. For example, the descriptive tag can be a reference identifier that is associated with a specific condition when determined from a condition reference database stored at the system data storage 140 and/or the data analysis system 150. The description identifier may also include other information, such as, but not limited to, the identity of the self-driving vehicle 110. In some embodiments, the data analysis system 150 can later identify the trigger condition associated with the subset of operation data based on the description identifier.

At step 450, the vehicle processor 212 transmits the subset of the operation data to the data analysis system 150.

In some embodiments, the vehicle processor 212 can transmit the subset of the operation data to the fleet management system 120, and the fleet management system 120 can transmit the subset of the operation data to the data analysis system 150.

The vehicle processor 212 may transmit the subset of the operation data in accordance with a transmission policy. The transmission policy can define one or more transmission parameters for transmitting the subset of the operation data to the data analysis system 150. The transmission policy may vary, depending on the particular trigger condition, mission, or self-driving vehicle 110. For example, the transmission policy may define particular timings for transmitting the subset of the operation data. The transmission policy may also define a particular data rate for transmitting the subset of the operation data. The transmission policy can coordinate the transfer of operation data between a plurality of self-driving vehicles 110 and the data analysis system 150. In some cases, each subset of the operation data can be large and may require significant network resources for transmission. The transmission policy can manage the transfer by efficiently using the network 130. In some embodiments, the vehicle processor 212 can request the transmission policy from the data analysis system 150 and/or the fleet management system 120 (for example, prior to step 450).

Additionally, the vehicle processor 212 may make the subset of the operation data available for direct download via the communication component 216. For example, the subset of the operation data may be made available for direct download via a SCP, FTP, or HTTP server, which may be hosted by the self-driving vehicle 110, or via an off-board server.

Once the data analysis system 150 receives the subset of the operation data, the data analysis system 150 can store the data, for example, at a data storage locally at the data analysis system 150 (not shown) or the system data storage 140. In some embodiments, the data analysis system 150 can, in response to receiving the subset of the operation data, index the subset of the operation data based on a set of description identifiers stored in a database accessible by the data analysis processor. The description identifiers can be used to label or identify the subset of the operation data. For example, the data analysis system 150 may index the data based on the particular trigger condition or self-driving vehicle 110 associated with the data.

The data analysis system 150 can also perform various analyses on the data. In some embodiments, the data analysis system 150 can initiate an analysis of the operation of the self-driving vehicle 110 in respect of the trigger condition. For example, the data analysis system 150 can perform an analysis of the data to identify the cause of the trigger condition.

As noted above, the subset of the operation data includes operation data collected before the trigger condition (i.e., the pre-condition period) and operation data collected after the trigger condition (i.e., the post-condition period). Accordingly, the data analysis system 150 can analyze data associated with the events leading up to, during, and after the trigger condition, from the perspective of the self-driving vehicle 110. For example, the data analysis system 150 may use the obstacle data from sensor 220a, and the image or video data from sensor 220b to determine the view of the self-driving vehicle 110, and determine the particular navigational decisions made by the self-driving vehicle 110.

It should be noted that the subset of the operation data is not necessarily limited to operation data directly related the trigger condition. Accordingly, the subset of the operation data can contain a comprehensive snapshot of the operation of the self-driving vehicle 110, and the data analysis system 150 can perform any analysis on the data appropriate to monitor the operation of the self-driving vehicle 110.

It should also be noted that in some embodiments where a fleet management system 120 is present, relevant data as retrieved from the fleet management system 120 can be added to the subset of the operation data.

The data analysis system 150 can store the results of the analysis, for example at the data storage at the data analysis system 150 (not shown) or the system data storage 140. The data analysis system 150, may in some embodiments, generate a report summarizing the results of the analysis. The report may, in some embodiments, be transmitted to a user device and/or the fleet management system 120 via the network 130.

It should be appreciated that, method 400 has been described with reference to the data analysis system 150. In some embodiments, one or more steps of method 400 may be implemented using the fleet management system 120.

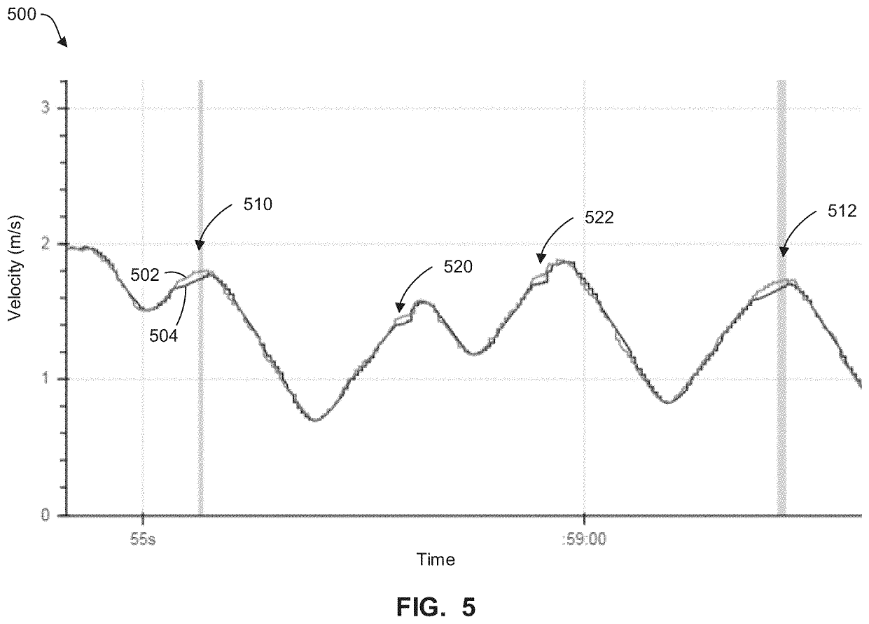

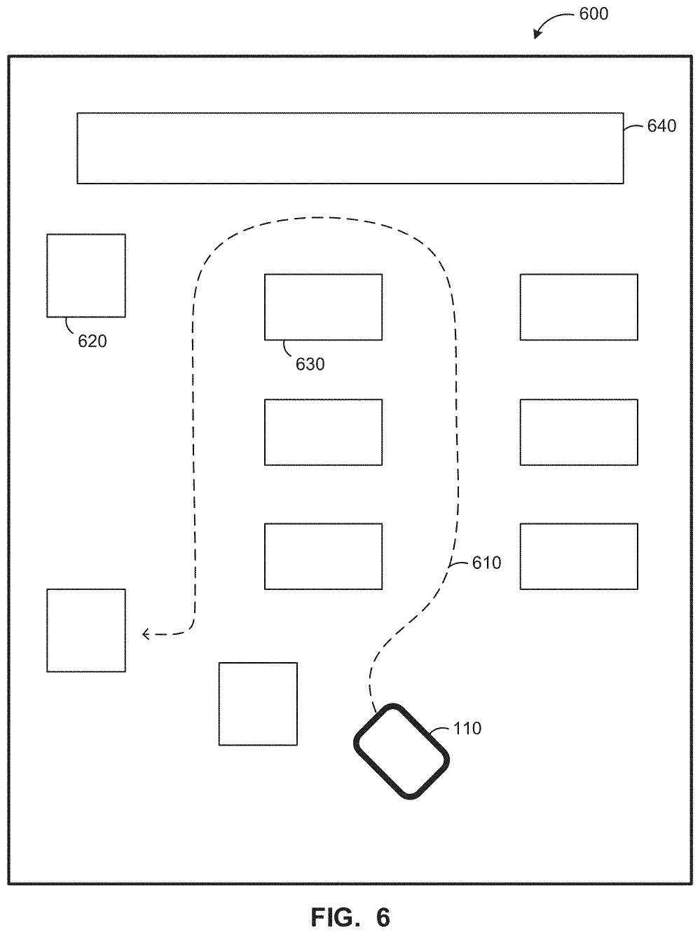

Reference is now made to FIGS. 5 and 6, which illustrate an example operation of a self-driving vehicle 110. For ease of exposition, FIG. 5 will be described with reference to FIG. 6. FIG. 5 shows a graph 500 illustrating data associated with the operation of the self-driving vehicle 110. The graph 500 depicts the navigation of a self-driving vehicle 110 through a facility during the execution of a mission. FIG. 6 illustrates a schematic of an example layout 600 of the facility in which the self-driving vehicle 110 can execute the mission.

As shown in FIG. 6, the self-driving vehicle 110 can travel through the facility to complete a mission, for example via path 610. The facility can be used for a variety of purposes, including, but not limited to, manufacturing plants, warehouses, offices, hospitals, hotels, and restaurants. The self-driving vehicle 110 can travel between various points within the facility to execute its mission, for example but not limited to, to pick-up and deliver items, to monitor the facility, and/or to collect data within the facility.

The velocity of the self-driving vehicle 110 can change over time as the self-driving vehicle 110 navigates the facility. For example, the self-driving vehicle 110 can slow down as it performs a turn, and then subsequently speed up after completing the turn. The self-driving vehicle 110 may also slow down to avoid obstacles in the facility. The obstacles can include, but are not limited to, staging stations 620, pallets 630, and shelf 640. The obstacles can include permanent objects, such as wall or pillars, as well as temporary or transient objects, such as carts, crates, bins, and pallets. The obstacles may also include other self-driving vehicles 110. The self-driving vehicle 110 may experience a loss of traction as it travels through the facility.

Referring now to FIG. 5, the graph 500 depicts the velocity of the self-driving vehicle 110 with respect to time. The velocity of the self-driving vehicle 110 changes over time (i.e., speeds up or slows down) as the self-driving vehicle 110 travels through the facility (e.g., avoiding obstacles 620, 630, and 640), while executing the mission.

At 510 and 512, the self-driving vehicle 110 experiences a loss of traction. The loss of traction may be caused by the environment of the self-driving vehicle 110 or may be caused by the self-driving vehicle itself. For example, the loss of traction can be caused by a low friction condition of the surface of the facility upon which the self-driving vehicle 110 is driving. In another example, the loss of traction can be caused by a failure in one or more wheels 232, 234 of the self-driving vehicle 110. For instance, one or more of the wheels 232, 234 can be mounted on casters, which rotate to align the wheels 232, 234 with the direction of travel. A sudden rotation of the caster can cause a wheel 232, 234 to lose traction temporarily.

The graph 500 includes a command data series 502 and a sensed data series 504. The command data series 502 corresponds to the expected velocity of the self-driving vehicle 110. The command data series 502 can be determined by the vehicle processor 212 and/or the data analysis system 150 based on the commands issued to the self-driving vehicle 110 via the vehicle control system 210. The sensed data series 504 corresponds to the measured velocity of the self-driving vehicle 110. The sensed data series 504 can be determined by the vehicle processor 212 and/or the data analysis system 150 via sensor readings from the sensing system 220 or the drive system 230.

As shown in graph 500, the command data series 502 and the sensed data series 504 will typically overlap under normal operation. That is, the predicted velocity of the self-driving vehicle 110 will usually be equal to the velocity sensed by the self-driving vehicle 110. However, a loss of traction of the self-driving vehicle 110 can cause a difference between the command data series 502 and the sensed data series 504. A loss of traction of the self-driving vehicle 110 will reduce the sensed velocity because the drive system 230 cannot properly drive the self-driving vehicle 110, whereas the velocity predicted based on commands will not change. For example, graph 500 depicts two loss of traction events at 510 and 512, respectively.

It should be noted that the self-driving vehicle 110 may only detect large differences between the command data series 502 and the sensed data series 504 as a loss of traction. For instance, the vehicle processor 212 may only determine a loss of traction if the difference between the command data series 502 and the sensed data series 504 exceeds a predetermined threshold. For example, the small differences at 520 and 522 are not considered loss of traction events.

As discussed above, the loss of traction may correspond to a trigger condition. For example, the detection of a loss of traction may cause the vehicle processor 212 to detect that a trigger condition is satisfied (e.g., at 420 of method 400), and transmit a subset of operation data to the data analysis system 150 (e.g., at 450 of method 400). The transmitted operation data can be analyzed at the data analysis system 150. In the present example, the operation data may be analyzed to determine the cause of the loss of traction.

The data analysis system 150 can analyze a variety of different types of data to determine the cause of the loss of traction. For example, the data analysis system 150 may analyze the video data collected from optical sensors 220b and 220c to review the driving surface upon which the self-driving vehicle drove before, during, and/or after the loss of traction. In another example, the data analysis system 150 may analyze data collected from the drive system 230 to review the behavior of the wheels 232, 234 and/or the casters (if present) before, during, and/or after the loss of traction. In some embodiments, the data analysis system 150 can analyze the data from multiple self-driving vehicles 110. For instance, the data analysis system 150 can analyze data from multiple self-driving vehicles 110 that each experienced a loss of traction in a similar location. The data analysis system 150 can then identify and/or flag the location to the fleet management system 120 and/or other appropriate notification systems, for example, to alert a user that the location may be slippery. In some embodiments, the data analysis system 150 can analyze the data from one self-driving vehicle 110 from multiple trigger conditions. For instance, the data analysis system 150 can analyze data from the same self-driving vehicle 110 that has experienced a loss of traction multiple times. The data analysis system 150 can then identify and/or flag the self-driving vehicle 110 to the fleet management system 120 and/or other appropriate notification systems, for example, to alert a user that the self-driving vehicle 110 may have a faulty drive system 230.

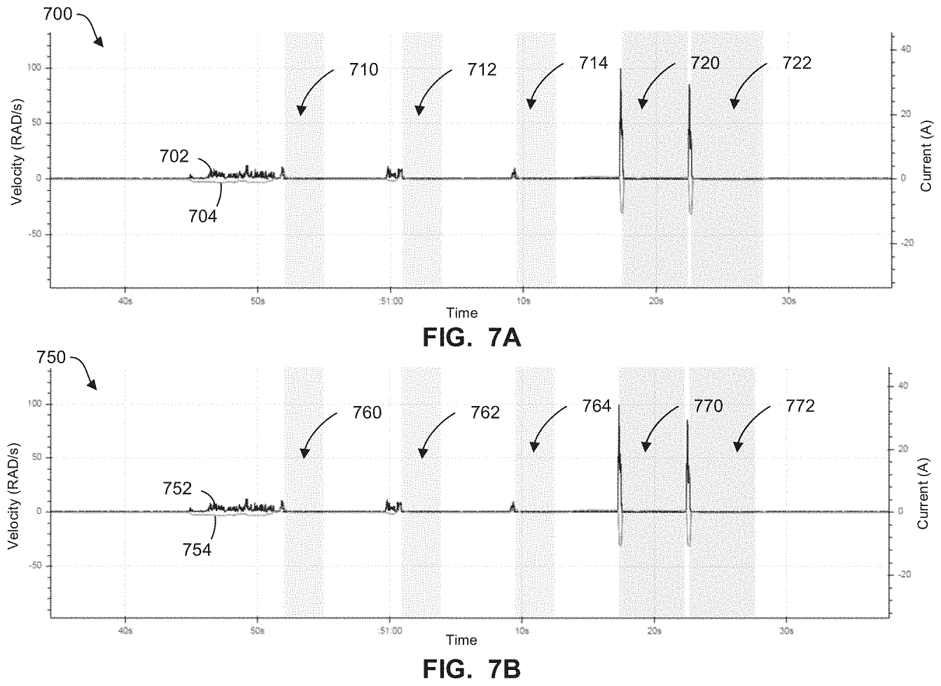

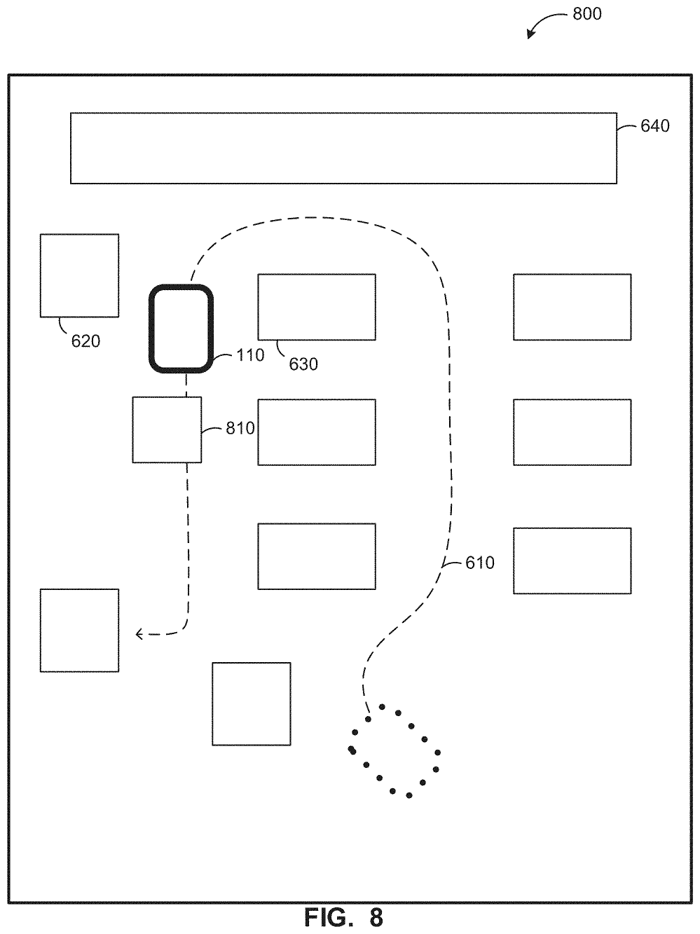

Reference is now made to FIGS. 7A, 7B and 8, which illustrate another example operation of the self-driving vehicle 110. FIGS. 7A, 7B, and 8 depict the operation of the same self-driving vehicle 110 (i.e., executing the same mission in the same facility), at a subsequent time to that shown in FIGS. 5 and 6. FIGS. 7A and 7B show graphs 700 and 750, which illustrate data associated with the operation of the self-driving vehicle 110. The graphs 700 and 750 depict the navigation of the self-driving vehicle 110 through the facility during execution of the mission, at the later time. FIG. 8 illustrates a diagram of a layout of the facility in which the self-driving vehicle 110 executes the mission at the subsequent time.

As shown in FIG. 8, the self-driving vehicle 110 has traveled further along the path 610, in comparison with the earlier state shown in FIG. 6. However, during the time of travel of the self-driving vehicle 110, an obstacle 810 has moved into the path 610 of the self-driving vehicle 110. The obstacle 810 may be any obstacle, including another self-driving vehicle 110. In order to avoid a collision with the obstacle 810, the self-driving vehicle 110 can attempt to perform a turn. However, the self-driving vehicle 110 may perform an emergency stop if the self-driving vehicle 110 detects an unsafe condition. For example, the self-driving vehicle 110 may detect that the obstacle 810 is too close to the self-driving vehicle 110. In another example, the self-driving vehicle 110 can detect that one or more of the wheels 232 is rotating too quickly (i.e., the self-driving vehicle is driving or turning too fast).

The graphs 700 and 750 depict the velocity of left drive wheel 232a and right drive wheel 232b with respect to time, respectively. As shown in the graphs 600A and 600B, the self-driving vehicle 110 attempts to turn several times, as the self-driving vehicle 110 attempts to avoid the obstacle 810. At 710, 712, 714, 720, 722, 760, 762, 764, 770 and 772, the self-driving vehicle 110 performs an emergency stop, suspending the movement of the self-driving vehicle 110.

The graphs 700 and 750 each include a current data series 702, 752 and a velocity data series 704, 754. The current data series 702, 752 corresponds to a respective measured currents supplied by the drive system 230 to propel the drive wheels 232a, 232b. The current data series 702, 752 may be determined by the vehicle processor 212 and/or the data analysis system 150 via the sensing system 220 or the drive system 230. The velocity data series 704, 754 correspond to the respective measured velocities of the drive wheels 232a, 232b. The velocity data series 704, 754 can be determined by the vehicle processor 212 and/or the data analysis system 150 based on via the sensing system 220 or the drive system 230. The current data series 702, 752 approximately resembles to the velocity data series 704, 754, as the current supplied to the drive system 230 to drive wheels 232 is related to the velocity of the drive wheels 232.

As discussed above, the emergency stops or the conditions that triggered the emergency stops can correspond to a trigger condition. For example, the detection of an emergency stop or the detection of conditions that trigger an emergency stop may cause the vehicle processor 212 to detect that a trigger condition is satisfied (e.g., at 420 of method 400), and transmit a subset of operation data to the data analysis system 150 (e.g., at 450 of method 400). The transmitted operation data can be analyzed at the data analysis system 150. In the present example, the operation data may be analyzed to determine the cause of the emergency stop.

The data analysis system 150 can analyze a variety of different types of data to determine the cause of the emergency stop. For example, the data analysis system 150 may analyze the video data collected from optical sensors 220b and 220c to review any obstacles nearby the self-driving vehicle 110 before, during, and/or after the loss of traction. In another example, the data analysis system 150 may analyze data collected from the drive system 230 to review the behavior of the drive system 230 before, during, and/or after the emergency stop. In another example, the data analysis system 150 may analyze log files, command signals, or messages to review the decision-making of the vehicle control system 210 before, during, and/or after the emergency stop.

Unless the context requires otherwise, throughout the specification and claims which follow, the word “comprise” and variations thereof, such as, “comprises” and “comprising” are to be construed in an open, inclusive sense, that is as “including, but not limited to.” It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies. In addition, as used herein, the wording “and/or” is intended to represent an inclusive or. That is, “X and/or Y” is intended to mean X or Y or both, for example. As a further example, “X, Y, and/or Z” is intended to mean X or Y or Z or any combination thereof. It should be noted that the term “coupled” used herein indicates that two elements can be directly coupled to one another or coupled to one another through one or more intermediate elements.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a keyboard, mouse, touchscreen, or the like), and at least one output device (e.g. a display screen, a printer, a wireless radio, or the like) depending on the nature of the device.

It should also be noted that there may be some elements that are used to implement at least part of one of the embodiments described herein that may be implemented via software that is written in a high-level computer programming language such as one that employs an object-oriented paradigm. Accordingly, the program code may be written in Java, C++ or any other suitable programming language and may comprise modules or classes, as is known to those skilled in object-oriented programming. Alternatively, or in addition thereto, some of these elements implemented via software may be written in assembly language, machine language or firmware as needed. In either case, the language may be a compiled or interpreted language.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail since these are known to those skilled in the art. Furthermore, it should be noted that this description is not intended to limit the scope of the embodiments described herein, but rather as describing exemplary implementations. Various modification and variations may be made to these example embodiments without departing from the spirit and scope of the invention, which is limited only by the appended claims.

1. A method for monitoring an operation of one or more self-driving vehicles, the method comprising:
operating a vehicle processor of a self-driving vehicle to:
collect, during operation, operation data associated with the operation of the self-driving vehicle;
detect, from the operation data, a trigger condition is satisfied during the operation;
determine, for the trigger condition, a pre-condition period and a post-condition period during which a subset of the operation data is to be retrieved for analyzing the operation of the self-driving vehicle in respect of the trigger condition, the pre-condition period defining a time period before the trigger condition occurred and the post-condition period defining a time period following the trigger condition;
retrieve, from a vehicle data storage, the subset of the operation data collected by the self-driving vehicle during the pre-condition period and the post-condition period;
request a transmission policy from a data analysis system remote from the self-driving vehicle via a network, the transmission policy defining one or more transmission parameters for transmitting the subset of the operation data to the data analysis system; and
transmit the subset of the operation data to the data analysis system according to the transmission policy.

2. The method of claim 1, wherein retrieving the subset of the operation data collected by the self-driving vehicle during the pre-condition period and the post-condition period comprises:
associating the subset of the operation data with at least one description identifier related to the trigger condition.

3. (canceled)

4. The method of claim 1, wherein detecting the trigger condition is satisfied during the operation comprises at least one of:
detecting, from the operation data, an error at the self-driving vehicle;
detecting, from the operation data, a completion of a mission assigned to the self-driving vehicle;
detecting receipt of a user triggered condition; or
detecting, from the operation data, a state change at the self-driving vehicle.

5. The method of claim 4, wherein detecting the error at the self-driving vehicle comprises:
receiving at least two conflicting data inputs related to the operation of the self-driving vehicle.

6.-9. (canceled)

10. The method of claim 4, further comprising operating the vehicle processor to:
determine an occurrence rate of the state change exceeds an occurrence threshold; and
in response to determining the occurrence rate exceeds the occurrence threshold, initiate a cool-down period following the post-condition period during which the vehicle processor operates to retrieve and transmit a reduced subset of operation data as the subset of the operation data.

11. The method of claim 1, wherein collecting the operation data associated with the operation of the self-driving vehicle comprises:
operating a sensing system at the self-driving vehicle to collect environmental data.

12. The method of claim 1, wherein determining the pre-condition period and the post-condition period comprises:
determining a severity level of the trigger condition; and
defining the pre-condition period and the post-condition period based on the severity level.

13. The method of claim 1, wherein determining the pre-condition period and the post-condition period comprises:
determining the trigger condition comprises the user-triggered condition;
determining a user type of a user initiating the user-triggered condition; and
defining the pre-condition period and the post-condition period based on the user type.

14. The method of claim 1, wherein determining the pre-condition period and the post-condition period comprises:
determining one or more vehicle characteristics of the self-driving vehicle; and
defining the pre-condition period and the post-condition period based on the one or more vehicle characteristics.

15.-16. (canceled)

17. The method of claim 1, further comprising operating the vehicle processor to:
in response to receiving the subset of the operation data, operating a data analysis processor of the data analysis system to index the subset of the operation data based on a set of description identifiers stored in a database accessible by the data analysis processor.

18. (canceled)

19. A system for monitoring an operation of one or more self-driving vehicles, the system comprising a vehicle processor of a self-driving vehicle configured to:
collect, during operation, operation data associated with the operation of the self-driving vehicle;
detect, from the operation data, a trigger condition is satisfied during the operation;
determine, for the trigger condition, a pre-condition period and a post-condition period during which a subset of the operation data is to be retrieved for analyzing the operation of the self-driving vehicle in respect of the trigger condition, the pre-condition period defining a time period before the trigger condition occurred and the post-condition period defining a time period following the trigger condition;
retrieve, from a vehicle data storage, the subset of the operation data collected by the self-driving vehicle during the pre-condition period and the post-condition period;
request a transmission policy from a data analysis system remote from the self-driving vehicle via a network, the transmission policy defining one or more transmission parameters for transmitting the subset of the operation data to the data analysis system; and
transmit the subset of the operation data to the data analysis system according to the transmission policy.

20. The system of claim 19, wherein retrieving the subset of the operation data collected by the self-driving vehicle during the pre-condition period and the post-condition period comprises:
associating the subset of the operation data with at least one description identifier related to the trigger condition.

21. (canceled)

22. The system of claim 19, wherein detecting the trigger condition is satisfied during the operation comprises at least one of:
detecting, from the operation data, an error at the self-driving vehicle;
detecting, from the operation data, a completion of a mission assigned to the self-driving vehicle;
detecting receipt of a user-triggered condition; or
detecting, from the operation data, a state change at the self-driving vehicle.

23. The system of claim 22, wherein detecting the error at the self-driving vehicle comprises:
receiving at least two conflicting data inputs related to the operation of the self-driving vehicle.

24.-27. (canceled)

28. The system of claim 22, wherein the vehicle processor is further configured to:
determine an occurrence rate of the state change exceeds an occurrence threshold; and
in response to determining the occurrence rate exceeds the occurrence threshold, initiate a cool-down period following the post-condition period during which the vehicle processor operates to retrieve and transmit a reduced subset of operation data as the subset of the operation data.

29. The system of claim 19, wherein collecting the operation data associated with the operation of the self-driving vehicle comprises:
operating a sensing system at the self-driving vehicle to collect environmental data.

30. The system of claim 19, wherein determining the pre-condition period and the post-condition period comprises:
determining a severity level of the trigger condition; and
defining the pre-condition period and the post-condition period based on the severity level.

31. The system of claim 19, wherein determining the pre-condition period and the post-condition period comprises:
determining the trigger condition comprises the user-triggered condition;
determining a user type of a user initiating the user-triggered condition; and
defining the pre-condition period and the post-condition period based on the user type.

32. The system of claim 19, wherein determining the pre-condition period and the post-condition period comprises:
determining one or more vehicle characteristics of the self-driving vehicle; and
defining the pre-condition period and the post-condition period based on the one or more vehicle characteristics.

33.-34. (canceled)

35. The system of claim 19, wherein the vehicle processor is further configured to:
in response to receiving the subset of the operation data, operating a data analysis processor of the data analysis system to index the subset of the operation data based on a set of description identifiers stored in a database accessible by the data analysis processor.

36.-105. (canceled)
